(19) United States
(12) Patent Application Publication
(10) Pub. No.: US 2004/0181472 A1
(43) Pub. Date: Sep. 16, 2004

(54) Timecard scanning system

(76) Inventor: Peter Jakubowski, Huntington Beach, CA (US)

Correspondence Address: STETINA BRUNDA GARRED & BRUCKER, 75 ENTERPRISE, SUITE 250, ALISO VIEJO, CA, 92656, US

(21) Appl. No.: 10/387,693

(22) Filed: Mar. 13, 2003

(51) Int. Cl. G06F 17/60

(52) U.S. Cl. 705/32

(57) ABSTRACT

An apparatus and processes are disclosed for generating personnel attendance data from stamped timecards. In accordance therewith, unstamped timecards are scanned to generate data representative of the unstamped timecard. Stamped timecards, e.g. having time/date data representative of the hours and days worked, are scanned to generate data representative of the stamped timecard. The data representative of the stamped timecard is then filtered by extracting therefrom data representative of the unstamped timecard to generate stamped attendance data representative of the hours and days worked. The attendance data is read, and then sorted into predetermined data fields.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention is directed to an apparatus and process for implementing accounting/payroll functions using a stamped timecard.

Timecards are widely used to keep track of the time that a worker spends at a job site and to determine the appropriate pay to that worker over a given period of time. Conventionally, the worker has a timecard which bears the worker's name with some work number that is unique to an individual worker. As the worker enters the job site, the worker takes his or her timecard and enters it into a time clock, which stamps the current date and time on the timecard. The time clock may be any of a variety of commercially available time clocks such as the model PIX-15 time clock marketed by Amano Cincinnati. When the worker leaves the job site, he or she again enters the timecard into the time clock, to stamp the departure date and time onto the card. Typically, the timecards are examined weekly, or on some other periodic interval, in order to tabulate the time that a particular worker has spent on a job site, and generate the appropriate paycheck. The process typically requires manual reading of the timecard, and entry of timecard data in payroll records, from which an appropriate paycheck may be prepared. In many cases the payroll data is entered into software accounting packages, such as Peachtree™, which simplify the collection and sorting of data to perform accounting and payroll functions. As such, manual data entry is typically required to interface the time clock data with the software accounting package. Such manual activity may be time consuming, subject to delays attributable to the need to address other activities, and may be error prone due to the tediousness of reading data stamped upon the timecards.

As will be apparent from the foregoing, it would useful to avoid the need for manual intervention in the process of interfacing timecard data with software accounting packages. This would not only free accounting personnel to do less mundane tasks, but also enhance the availability of payroll data in between periodic payroll processing dates. Moreover, it is preferable that such machine driven data entry processes be implemented with a high degree of accuracy that may enhance the overall accuracy level of the payroll accounting process.

The present invention is directed to such an apparatus and process that mitigates or voids the need for manual entry of payroll data from timecards into payroll records, or software accounting programs. The present invention is further directed to an apparatus and system whereby timecards may remain at a work site though the timecard data can be communicated to a remote, off-site location wherein the data can be read, sorted and operated on to generate appropriate accounting and payroll information, as well as generating appropriate payroll checks.

These and other object and advantages of the present invention are set forth in conjunction with the appended drawings and disclosure set forth herein.

### BRIEF SUMMARY OF THE INVENTION

An apparatus and processor are disclosed for generating personnel attendance data from stamped timecards. In accordance therewith, un-stamped timecards are scanned to generate data representative of the unstamped timecard. Stamped timecards, e.g. having time/date data representative of the hours and days worked, are scanned to generate data representative of the stamped timecard. The data representative of the stamped timecard is then filtered by extracting therefrom data representative of the unstamped timecard to generate stamped attendance data representative of the hours and days worked. The attendance data is read utilizing optical character recognition techniques to interpret the attendance data, which is then sorted into predetermined data fields.

The attendance data may include personnel identification information, such as a name or identifying number that may be stamped or written onto the timecard. The attendance date may be sorted into data fields respecting personnel daily attendance, absences, vacation time, overtime or tardiness. The data fields may be selected in accordance with associated accounting programs such that the data fields may serve as inputs to the accounting programs to facilitate the issuance of appropriate payroll checks, and to maintain conventional attendance records.

Scanning of the stamped/unstamped timecards may be implemented by conventional scanners, such as a card scanner or flatbed scanner.

The scanned data representative of the unstamped/stamped timecards may be processed locally proximate the location of the scanners, or communicated to a remote location, such as by internet communication links, where the data may be filtered, read, sorted and/or otherwise processed by a centralized data processor/check issuing system.

### BRIEF DESCRIPTION OF THE DRAWINGS

These as well as other features of the present invention will become more apparent upon reference to the drawings wherein:

FIG. 1 is a illustration of a blank timecard;

FIG. 2 is an illustration of a timecard having data stamped thereon;

FIG. 3 is an illustration of a timecard being read by scanner;

FIG. 4 is flow chart illustrating an exemplary system implemented in accordance with the present invention;

FIG. 5 illustrates the data report that may be generated in accordance with the present invention.

### DETAILED DESCRIPTION OF THE INVENTION

The description below sets forth the structure and function of the present invention, as implemented in the presently preferred embodiment thereof. The discussion sets forth the sequence of steps that may be implemented in accordance with the invention, and the equipment and software that may be utilized to carry out those steps. However, as will be apparent to those skilled in the art, the particular sequence of steps may be modified or supplemented in response to particular requirements or operating conditions. Similarly, the equipment utilized to implement the invention may be substituted or supplemented as desired to achieve additional functionality, to interface with alternative software packages, to accommodate different types of timecards, or to generate different types of payroll/accounting records and payments. As such, those additions, enhancements and modifications are intended to be encompassed within the broader aspects of the invention, which are set forth below and recited in the appended claims.

In general terms, the present invention allows for an automated interface and interpretation of the timecard data, to a form directly usable in accounting software packages or other accounting reports. In accordance with the present invention timecards are scanned, filtered to remove form data, and read to derive the stamped data and related information, e.g. worker identification, days and hours worked, overtime, absences, etc. That data may be sorted to appropriate fields for reporting purposes, and/or placed in a form in which it may be operated on by conventional software accounting packages. Appropriate payroll checks may be generated from the manual review of the accounting reports, or by operation of the software accounting packages.

By implementation of the present invention the accounting functions may be implemented at a location remote from the location of the timecards, which need not be manually reviewed by accounting personnel responsible for payroll functions. However, a visual image of the paychecks is available for accounting personnel to review in the event that questions arise respecting particular timecard data.

As will further be apparent to those of ordinary skill, the present invention may be implemented in conjunction with various enhanced time clock/security systems, for example, systems incorporating visual images of the worker, or other electronic identifiers that may be appended to time clock data to enhance security, prevent “buddy punching” or otherwise facilitate the reliability of personnel accounting functions.

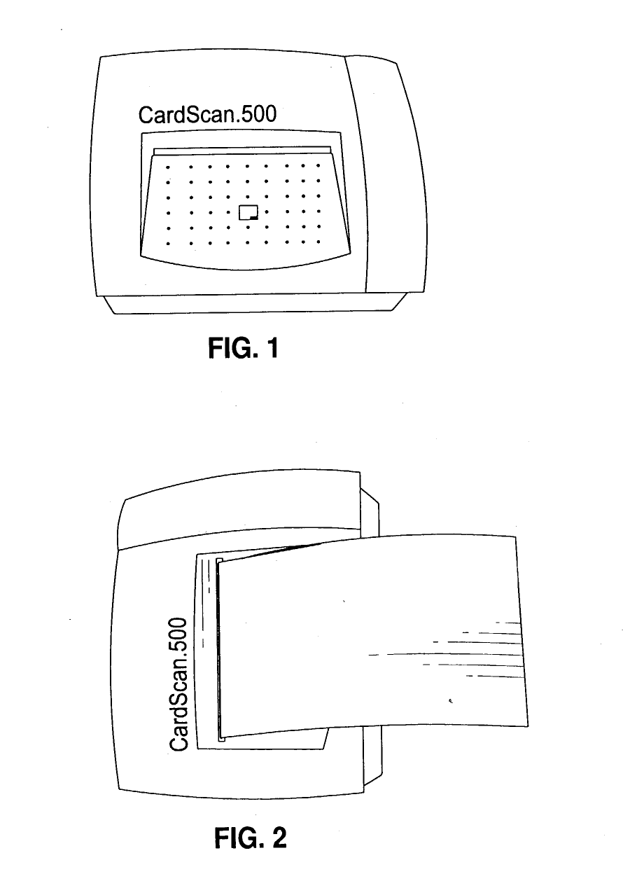

Turning to the drawings, FIG. 1 illustrates a representative timecard as may be used in conjunction with the present invention. As shown therein the timecard 11 is typically implemented as a form, which includes printed material identifying certain data fields, such as date, time of day and in/out fields, identifying when the worker arrives and leaves the workplace. The timecard also provides area for identification of the workers' name and/or identifying number.

FIG. 2 illustrates a timecard 13 similar to that shown in FIG. 1, wherein the timecard has been stamped with data, representative of the arrival time/departure time and date representative of the attendance of a particular worker.

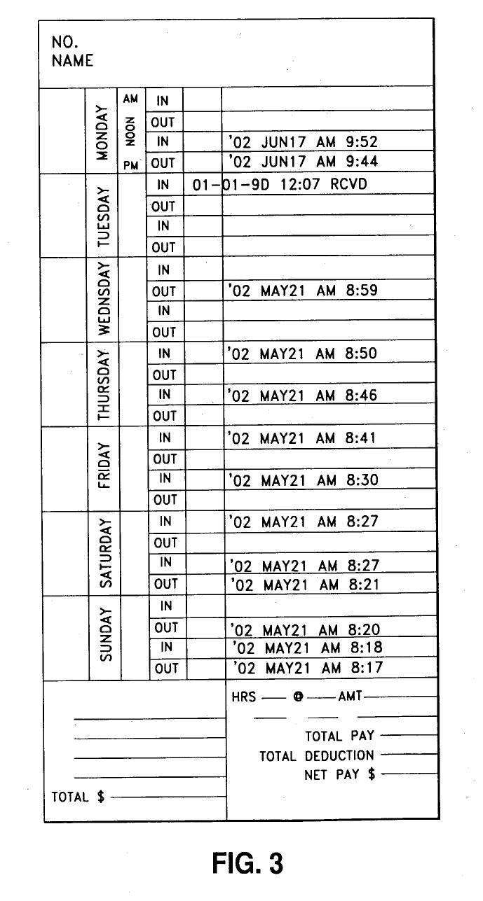

FIG. 3 illustrates an exemplary 15 scanner that may be used to read the unstamped timecard 11, as shown at FIG. 1, and/or the stamped timecard 13, as shown at FIG. 2. The scanner 15 may be implemented as a card scanner, which is typically be utilized to read business cards or the like. It has been determined that such scanners may also be effective to read timecards, such as those shown in FIGS. 1 and 2. However, it is to be understood that the scanner 15 may be any other type of scanner such as a flatbed scanner, which is operative to convert the timecard into an electronic image that may later be operated on, as described below.

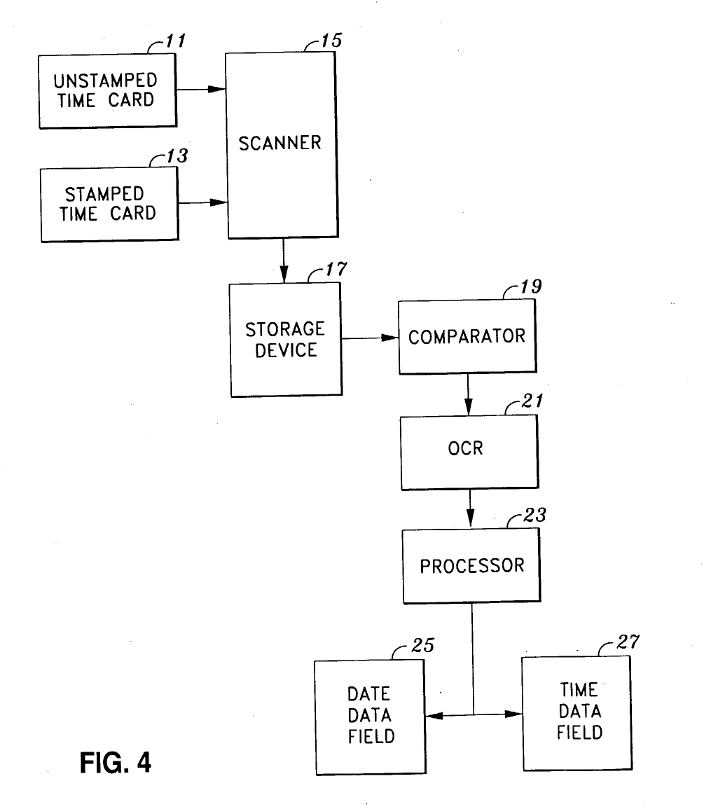

FIG. 4 illustrates a block diagram of the apparatus and process implemented in accordance with the present invention. As illustrated therein the scanned timecard data may be operated upon to filter the form information to segregate the stamped information on the timecard, for reading and processing. Various methods of filtering may be utilized to implement this functionality. Form Reader, by ABBYY Software House is representative of desktop applicator programs useful to process forms and capture data entered on the forms.

The filtered or captured timecard data may be operated by an optical character recognition (OCR) system or the like that interprets alpha-numerical data. That captured data may then be sorted to appropriate categories, such as worker identification, time, date, in/out, weekends, etc. Once the information is appropriately sorted it may be reported and printed in that form or interfaced with accounting software packages which operate upon such fields of data to generate accounting reports/information/payroll checks.

As noted above the filtering, reading, sorting, and accounting functions may be implemented remote from the location of the timecards and timecards scanners. As such, the need for on-site accounting personnel may be substantially mitigated without compromising the accuracy, adaptability or functionality of the system. In addition to issuance of paychecks, accounting records regarding functions such as sick days, vacation time, etc. may be properly accounted without the need for manual oversight of timecards.

Referring to FIG. 4, an exemplary process and system for utilizing the present invention is provided. As shown therein, the scanner 15 adapted to scan unstamped timecard 11, and stamped timecard 13. Scanner 15 is operative to generate electronic representations of the cards 11,13, which may be stored in a storage device 17. Storage device 17 is operative to communicate information stored therein, such as the digital representations of unstamped timecard 11 and stamped timecard 13, to a comparator 19, or other filtering/data extraction device that is, for example, operative to compare the electronic representations and extract stamped or written data on the timecard form, such as the workers name and stamp data representative of the date and time the worker clocked in/clocked out. The extracted or filtered data can be interpreted, e.g. is by means of an optical character reader 21, to allow identification and interpretation of the filtered data. The optical character recognition functionality may be implemented by temporary hardware/software programs, such as Form Reader software from ABBYY Software House. Once the filtered data has been identified, it may be forwarded to appropriate predetermined data fields, such as date data field 25 and time data field 27. The data field(s) may be operated on at the site of the scanner, or at a remote location. Data fields may be established in conformance with a particular accounting program that is intended to operate on the sorted data. For example, date information may be sorted to a date data field, which corresponds to the operating data fields used by contemporary accounting programs, operating in processor 23. Processor 23 may rely upon operation of such accounting programs to generate a variety of information, and to perform a variety of functions which are generally associated with such programs. For example, the processor 23, which may be implemented as a personal computer, may operate to tabulate collective hours worked by a worker over a predetermined period of time, and generate appropriate corresponding paycheck. The accounting programs may further keep track of occurrences such as absences, vacation time, overtime, tardiness, and other circumstances as may be useful to maintain personnel records and perform appropriate accounting functions.

As noted above, the system/processing technique described above may be distributed so as to be implemented at more than one location. For example, the scanner may be disposed at a workplace location proximate the time clock. However, the scanner output may be communicated, either directly or through an associated personal computer, to a remote location where the unique stamped or written information is extracted from the scanned image of the stamped timecard, read, sorted, and processed to effectuate the personal information and accounting functions identified above. A remote location, such as a corporate accounting office, may receive the scanned data by means such as phone cables, and/or via internet based communication lines. Similarly, the accounting functions may themselves be distributed such that accounting records are generated at one location and payroll checks are issued at another location. Those skilled in the art will recognize that these and other such modifications, distributions and enhancements of the present invention may be implemented without departing from the broader aspects thereof.

What is claimed:

1. A process for operating personal attendance data from stamped timecards comprising:
a) scanning an unstamped timecard to generate data representative of the unstamped timecard;
b) scanning a stamped timecard having time/date data representative of hours and days worked to generate data representative of the stamped timecard;
c) filtering the data representative of the stamped timecard by extracting the data representative of the unstamped timecard from the data representative of the stamped timecard, to capture attendance data representative of the hours and days worked;
d) reading the attendance data; and
e) sorting the attendance data into predetermine data fields.

2. The process as recited in claim 1, further comprising the step of communicating the sorted attendance data to a software accounting program operative to generate a collective record of the hours and days worked, and to issue corresponding paychecks.

3. The process as recited in claim 1, further comprising the step of communicating the data representative of the un-stamped timecard and the data representative of the stamped timecard to a remote location, where the steps of filtering, reading and sorting are implemented.

4. The process as recited in claim 1, wherein the stamped timecard includes personal identification information.

5. The process as recited in claim 4, wherein the attendance data includes data representative of the personal identification information.

6. The process as recited in claim 1, wherein the scanning is implemented by a card scanner.

7. The process as recited in claim 1, wherein the scanning is implemented by a flatbed scanner.
